(19) United States
(12) Patent Application Publication
(10) Pub. No.: US 2005/0181797 A1
(43) Pub. Date: Aug. 18, 2005

(54) Method, system, and computer program for allocating radio resources in TDMA cellular telecommunications system

(76) Inventor: Olli Piirainen, Oulu (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/819,346

(22) Filed: Apr. 7, 2004

(30) Foreign Application Priority Data
Feb. 12, 2004 (FI) 20040216

(51) Int. Cl. H04Q 7/00

(52) U.S. Cl. 455/446; 455/450

(57) ABSTRACT

A method, a computer program and a system for allocating radio resources are provided for a TDMA cellular telecommunications system which applies spatial diversity and cell-specific radio frequency bands. The system for allocating the radio resources includes a frequency allocating network element for allocating radio frequency bands to at least two radio cells located within a reuse distance from each other, at least one overlap region being formed between the radio frequency bands, the at least one overlap region being reserved for a simultaneous use in the same transmission direction of the at least two radio cells. The invention provides a frequency reuse capability for radio cells located within a reuse distance from each other.

### FIELD

The invention relates to a method of allocating radio resources in a cellular telecommunications system, a system for allocating radio resources in a cellular telecommunications system, and a computer program for allocating radio resources in a cellular telecommunications system.

### BACKGROUND

Frequency planning plays a key role when considering the performance of a TDMA (Time Division Multiple Access) cellular telecommunications system. The frequency planning typically defines the radio frequency bands to be allocated to radio cells and aims at providing radio links with a minimum interference level between them. The minimum interference level is typically obtained by assigning cell-specific radio frequency bands to the radio cells such that the radio frequency bands of the proximity cells are separated from each other.

The performance of the TDMA cellular telecommunications system may be considerably improved by utilizing spatial diversity, which is typically achieved by applying multi-antenna arrays in radio signal transfer between the infrastructure and mobile stations. However, taking the spatial diversity into account complicates the frequency planning since more degrees of freedom contributing to the link performance are introduced. Therefore, it is useful to consider improvements for allocating radio resources when spatial diversity is applied.

### BRIEF DESCRIPTION OF THE INVENTION

An object of the invention is to provide an improved method, system, and computer program for allocating radio resources in a TDMA cellular telecommunications system.

According to an aspect of the invention, there is provided a method of allocating radio resources in a TDMA cellular telecommunications system, which applies spatial diversity and where radio cells are assigned cell-specific radio frequency bands selected from a plurality of radio frequency bands. The method comprises the steps of allocating radio frequency bands to at least two radio cells, the at least two radio cells being located within a reuse distance from each other; and forming at least one overlap region between the radio frequency bands, the at least one overlap region being reserved for a simultaneous use in the same transmission direction of the at least two radio cells.

According to a second aspect of the invention, there is provided a system for allocating radio resources in a TDMA cellular telecommunications system, which applies spatial diversity, and where radio cells are assigned cell-specific radio frequency bands selected from a plurality of radio frequency bands. The system comprises a frequency allocating network element for allocating radio frequency bands to at least two radio cells located within a reuse distance from each other; and at least one overlap region being formed between the radio frequency bands, the at least one overlap region being reserved for a simultaneous use in the same transmission direction of the at least two radio cells.

According to another aspect of the invention, there is provided a computer program embodied in a computer readable medium, the computer program executes a computer process for allocating radio resources in a TDMA cellular telecommunications system which applies spatial diversity and where radio cells are assigned cell-specific radio frequency bands selected from a plurality of radio frequency bands. The computer process comprises the steps of allocating radio frequency bands to at least two radio cells, the at least two radio cells being located within a reuse distance from each other; and forming at least one overlap region between the radio frequency bands, the at least one overlap region being reserved for a simultaneous use in the same transmission direction of the at least two radio cells.

According to another aspect of the invention, there is provided an apparatus for allocating radio resources in a TDMA cellular telecommunications system, which applies spatial diversity and where radio cells are assigned cell-specific radio frequency bands selected from a plurality of radio frequency bands. The apparatus comprises allocating means for allocating radio frequency bands to at least two radio cells, the at least two radio cells being located within a reuse distance from each other; and forming means for forming at least one overlap region between the radio frequency bands, the at least one overlap region being reserved for a simultaneous use in the same transmission direction of the at least two radio cells.

Preferred embodiments of the invention are described in the dependent claims.

The method, system and computer program of the invention provide several advantages. In a preferred embodiment of the invention, the invention provides a frequency reuse capability for radio cells located within a reuse distance from each other. The frequency reuse capability, for example, increases the maximum capacity at the link and system level, increases the coverage of a base transceiver station, and increases the cost-efficiency of the use of the infrastructure of the TDMA cellular telecommunications system.

### LIST OF DRAWINGS

In the following, the invention will be described in greater detail with reference to the preferred embodiments and the accompanying drawings, in which

FIG. 1A shows a first example of the structure of a TDMA cellular telecommunications system;

FIG. 1B shows an example of the allocation of radio frequency bands to radio cells according to prior art;

FIG. 2 shows a second example of the structure of a TDMA cellular telecommunications system;

FIG. 3 illustrates a first example of the allocation of radio frequency bands to radio cells according to embodiments of the invention;

FIG. 4 illustrates an example of a radio cell structure;

FIG. 5 illustrates a second example of the allocation of radio frequency bands to radio cells according to embodiments of the invention;

FIG. 6 illustrates another example of the allocation of radio frequency bands to radio cells according to embodiments of the invention, and

FIG. 7 shows an example of methodology according to embodiments of the invention with a flow chart presentation.

### DESCRIPTION OF EMBODIMENTS

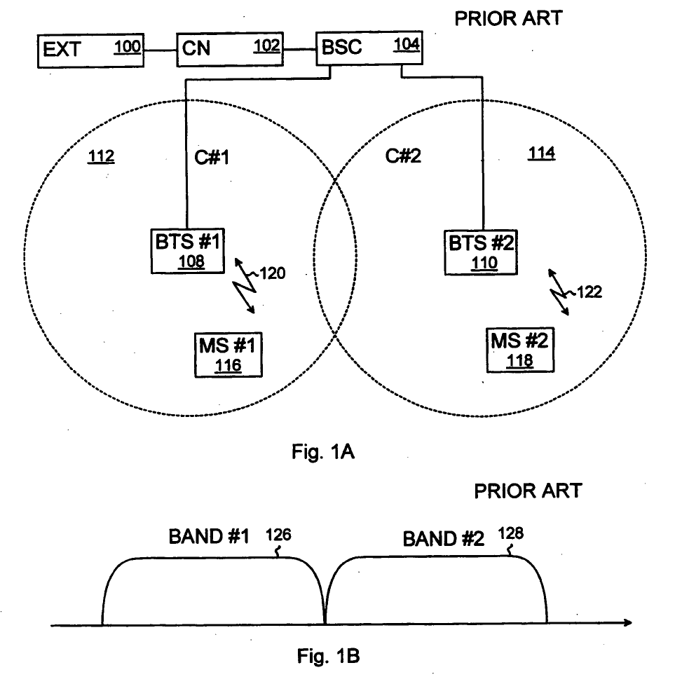

With reference to FIG. 1A, an example of the structure of a TDMA (Time Division Multiple Access) cellular telecommunications system is shown.

The TDMA cellular telecommunications system may include, for example, a GSM (Global System for Mobile Communications) system, a GSM/EDGE (GSM/Enhanced Data Rates for Global Evolution) system, a GPRS (General Packet Radio Service) system, an E-GPRS (EDGE GPRS) system, or a US-TDMA (US Time Division Multiple Access) system. For the ease of discussion, preferred embodiments of the invention will be described in terms of the GSM system without limiting the scope of the invention to the GSM system, as will be obvious to one skilled in the art.

The TDMA cellular telecommunications system according to the example includes a core network (CN) 102, a base station controller (BSC) 104, external networks (EXT) 100 connected to the core network 102, base transceiver stations (BTS#1, BTS#2) 108, 110, and mobile stations (MS#1, MS#2) 116, 118.

The core network 102 may include a circuit-switched domain for managing circuit-switched traffic between the mobile stations 116, 118 within the same telecommunications system and/or between the mobile station 116, 118 and the external networks 100. In such a case, the external networks 100 may include a public land mobile network (PLMN) or a public switched telephone network (PSTN), for example.

The core network 102 may include a packet-switched domain for managing packet-switched traffic between the mobile stations 116, 118 within the same telecommunications system and/or between the mobile station 116, 118 and the external networks 100. In such a case, the external networks 100 may include the Internet, for example.

The detailed structure of the core network 102 is known to one skilled in the art and will be described when relevant to the present invention.

The base transceiver station 108, 110 provides the transceiver functions of the infrastructure of the TDMA cellular telecommunications system. The tasks of the base transceiver station 108, 110 include, for example: calculation of timing advance (TA), uplink measurements, channel coding, encryption, decryption, frequency hopping, and an interference cancellation means. The base station controller may include a computer for executing computer processes, memory for storing data and computer programs, and a user interface. The detailed structure of the base transceiver station 108, 110 is known to one skilled in the art and will be described when relevant to the present invention.

The base station controller 104 controls the base transceiver stations 108, 110 and typically performs the following tasks: radio resource management of the base transceiver stations 108, 110, inter-cell handovers, frequency control, i.e. radio frequency band allocation to the base transceiver stations 108, 110 and mobile stations 116, 118, management of frequency hopping sequences, time delay measurement on the uplink, implementation of the operation and maintenance interface, and power control.

The mobile station 116, 118 comprises a radio modem for communicating with the base transceiver station 108, 110 over the radio link 120, 122.

The mobile station 116, 118 may further comprise an identity module for identifying the mobile station 116, 118 in the telecommunications system. The mobile station 116, 118 may further include an antenna, a user interface, an interference cancellation means, and a battery. The detailed structure of the mobile station 116, 118 is known to one skilled in the art and will be described when relevant to the present invention.

One base transceiver station 108, 110 may serve one radio cell 112, 114 or a plurality of radio cells. Each radio cell 112, 114 is typically assigned a cell-specific radio frequency band selected from a plurality of radio frequency bands allocated to the TDMA cellular telecommunications system. The cell-specific radio frequency band defines the frequency range applied by the radio link 120, 122.

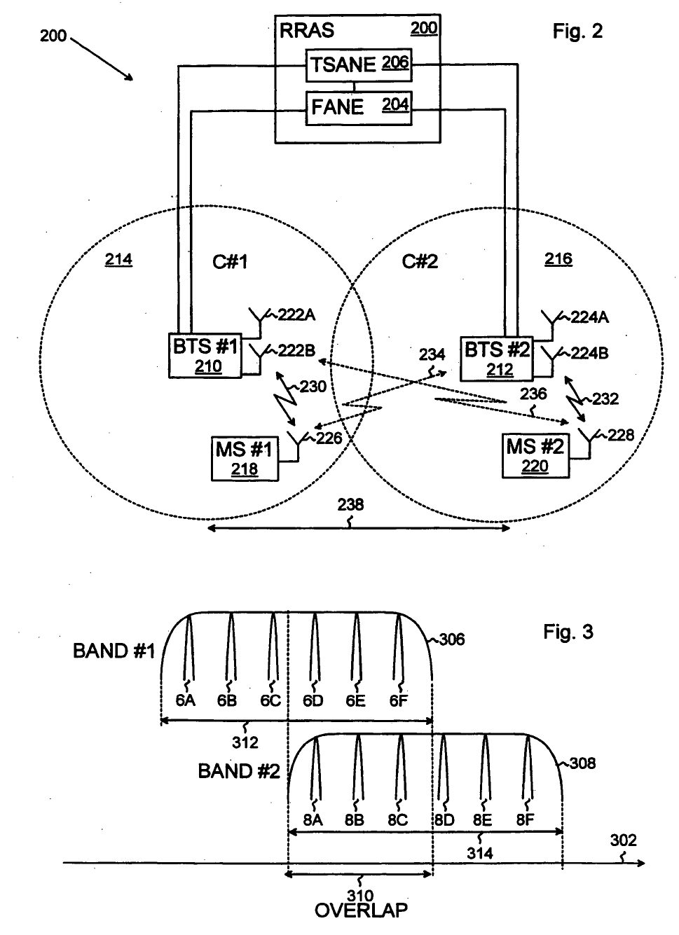

With reference to FIG. 2, a system (RRAS) 200 for allocating radio resources in the TDMA cellular telecommunications system includes a frequency allocating network element (FANE) 204 for allocating the radio frequency bands 306, 308 shown in FIG. 3 to radio cells 214, 216.

The frequency allocating network element 204 may be located in the base station controller 104 or in the base transceiver station 210, 212, for example.

The frequency allocating network element 204 may be implemented with a computer and appropriate software.

In the example of FIG. 2, a mobile station 218 (MS#1) is located within the coverage area of the radio cell 214 (C# 1) and may have a radio link 230 with the base station 210 (BTS#1). The mobile station (MS#1) 218 may cause an interference signal 234 to the base transceiver station (BTS#2) 212.

The mobile station 220 (MS#2) is located within the coverage area of the radio cell 216 (C#2) and may have a radio link 232 with the base station 212 (BTS#2). A mobile station (MS#2) 220 may cause an interference signal 236 to the base transceiver station (BTS#1) 210.

The TDMA cellular telecommunications system according to the invention applies spatial diversity, which is typically achieved by applying a diversity antenna arrangement to the radio link 230, 232 between the base transceiver station 210, 212 and the mobile station 218, 220. The diversity antenna arrangement includes at least two independent antennas, which may be separated from each other by a physical distance and/or a polarization angle. The physical distance between proximity antennas is typically more than half of the wavelength of the radio frequency carrier. The diversity antenna arrangements are known to one skilled in the art and will be described when relevant to the present invention.

Each independent antenna is typically connected to an antenna-specific conversion chain, which performs a conversion between an antenna radio frequency signal and a base band digital signal. The conversion chain may be divided into a transmit chain and a receive chain.

The transmit chain typically converts a digital base band transmit signal into a radio frequency transmit signal, which is transmitted by the antenna. The structure of the transmit chain is known to one skilled in the art and is not discussed in detail in this context.

The receive chain typically converts a radio frequency receive signal received by the antenna into a digital base band receive signal. The structure of the receive chain is known to one skilled in the art and is not discussed in detail in this context.

In an embodiment, the diversity antenna arrangement is located in the base transceiver station 210, 212. In such a case, the mobile station 218, 220 may utilize a single antenna or a diversity antenna arrangement.

In an embodiment, the diversity antenna arrangement is located in the mobile station 218, 220. In such a case, the base transceiver station 210, 212 may utilize a single antenna or a diversity antenna arrangement.

In the example of FIG. 2, the base transceiver station (BTS#1) 210 includes at least two independent antennas 222A, 222B, which are connected to antenna-specific transmit/receive chains not shown in FIG. 2. The base transceiver station (BTS#2) 212 may include at least two independent antennas 224A, 224B, which are connected to antenna-specific transmit/receive chains not shown in FIG. 2. Different base transceiver stations 210, 212 may have a different number of antenna elements.

In the example of FIG. 2, the mobile station (MS#1) may include a single antenna 226. The mobile station (MS#2) may include a single antenna 228.

A reuse distance 238 is a prior art frequency planning parameter defined in the prior art, and it characterizes a minimum separation of radio cells which may apply the same frequencies simultaneously in the same transmission direction. It should be emphasized that the definition of the reuse distance 238 follows that of the conventional idea where a cellular telecommunications system does not apply spatial diversity, or spatial diversity is considered in a restricted manner in frequency planning. According to the prior art, non-over-lapping radio frequency bands, such as the radio frequency bands 126, 128 shown in FIG. 1B, would only be allocated to the radio cells 112, 114 located within the reuse distance 238.

In an embodiment, the radio cells 214, 216 are adjacent radio cells. In such a case, the reuse distance 238 is of the order of the cell size.

With reference to the example shown in FIG. 3, a radio frequency band (BAND# 1) 306 is allocated to the radio cell (C# 1) 214. A radio frequency band (BAND#2) 308, correspondingly, is allocated to the radio cell (C#2) 216. The vertical axis 302 shows a radio frequency in an arbitrary unit.

The radio frequency band (BAND#1) 306 and the radio frequency band (BAND#2) 308 overlap, thus forming an overlap region 310. The overlap region 310 includes at least one frequency component, which is common to the radio cells 214, 216. The overlap region 310 is reserved for a simultaneous use in the same transmission direction of the radio cell (C#1) 214 and the radio cell (C#2) 216.

When the overlap region 310 is reserved for the simultaneous use in the same transmission direction of the radio cell (C#1) 210 and the radio cell (C#2) 212, at least a portion of the overlap region 310 may be dedicated to the radio link 230 and radio link 232, which apply the same time slots and have the same transmission direction. The transmission direction may be the downlink direction or the uplink direction, depending on the embodiment.

The radio frequency band (BAND#1) 306 may include carrier frequencies 6A, 6B, 6C, 6D, 6E, 6F, which may be equally separated from each other. The number of carrier frequencies 6A to 6F may depend on the required bandwidth 312 of the radio frequency band (BAND#1) 306 and the separation of the carrier frequencies 6A to 6F.

The radio frequency band (BAND#2) 308 may include carrier frequencies 8A, 8B, 8C, 8D, 8E, 8F, which may be equally separated from each other. The number of carrier frequencies 8A to 8F may depend on the required bandwidth 314 of the radio frequency band (BAND#2) 308 and the separation of the carrier frequencies 8A to 8F.

The carrier frequencies 6A to 6F and 8A to 8F may be the carrier frequencies of the GSM system, in which a typical separation of adjacent carrier frequencies is 200 kHz.

If the radio frequency bands 306, 308 are formed by carrier frequencies, the overlap region 310 includes at least one carrier frequency common to the radio frequency band (BAND#1) 306 and the radio frequency band (BAND#2) 308. In the example of FIG. 3, a group of carrier frequencies 6D, 6E, 6F of the radio frequency band (BAND#1) 306 overlaps a group of carrier frequencies 8A, 8B, 8C of the radio frequency band (BAND#2) 308 carrier by carrier. Thus, the carrier frequencies 6D, 6E, 6F are reserved for a simultaneous use for the cell (C#1) 214 and the cell (C#2) 216 in the same transmission direction.

The frequency allocating network element 204 may include a carrier register, which contains a list of carriers available for frequency allocation. The carriers may be associated with a carrier-specific carrier number. The carrier numbers may be signalled to the base transceiver station 210, 212 and to the mobile station 218, 220 in order to allocate the required carrier or carriers for the link 230, 232.

In an embodiment of the invention, the system 200 includes a training sequence allocating network element (TSANE) 206 for allocating cell-specific training sequences to the at least two radio cells 214, 216. The cell-specific training sequences allow a receiver to distinguish between two transmitters transmitting simultaneously at the same frequency, and carry out e.g. channel estimation for a correct transmitter. With reference to FIG. 2, the base transceiver station 210 and the mobile station 218 may be allocated a first training sequence. The base transceiver station 212 and the mobile station 220, respectively, may be allocated a second training sequence, which is different from the first training sequence. The use of the different training sequences enables the base transceiver station 210, 212 to distinguish between training sequences from the two mobile stations 218, 220 and associate the channel estimate with the correct mobile station 218, 220.

The training sequence allocating network element 206 may be comprised in the base station controller 104 or in the base transceiver station 108, 110. The training sequence allocating network element 206 may be implemented with a computer and software. The information on the applied training sequences may be transferred to the base transceiver stations 210, 212 and the mobile stations 218, 220 with known signalling channels.

With reference to FIG. 4, a TDMA cellular telecommunications system may include a radio cell structure 400, which includes radio cells 402 to 418. For the ease of illustration, the radio cell structure 400 is shown by means of a polygon model without restricting the invention to any shape or arrangement of radio cells, as is clear to one skilled in the art. Radio cells (C#1) 402, (C#2) 404, and (C#3) 406 may be formed by a single base transceiver station 210, 212 or cell-specific base transceiver stations 210, 212.

Let us consider an exemplary case where frequencies are allocated to the radio cells (C#1) 402, (C#2) 404, and (C#3) 406, which are located within a reuse distance 424 from each other. The reuse distance 424 may define a reuse area 428, such as a sphere. In this example, the cells (C#1) 402, (C#2) 404, and (C#3) 406 are included in the same reuse area 428.

According to the prior art, only separated frequency bands would be allocated to the radio cells (C#1) 402, (C#2) 404, and (C#3) 406 in the reuse area 428.

Another reuse area 430 including radio cells (C#2) 402, (C#4) 408, and (C#5) 410, for example, may be defined by a second reuse distance 426 elsewhere in the radio cell structure 400. Frequency allocation to the cells (C#2) 404, (C#4) 408, and (C#5) 410 within the reuse area 430 may be performed by using the principles described in connection with the reuse area 428 by taking into account the frequency allocation of the overlap cell (C#2) 404, which belongs to both reuse areas 428 and 430 under consideration. With the principle shown, the entire radio cell structure 400 of the TDMA cellular telecommunications system may be provided with radio frequencies.

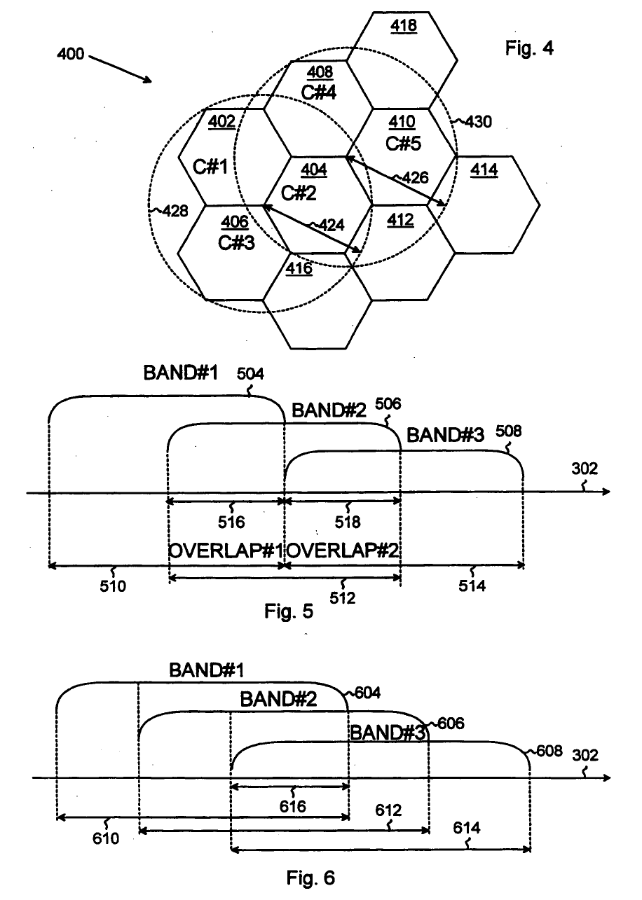

With reference to FIG. 5, in an embodiment, radio frequency bands (BAND#1) 504, (BAND#2) 506, and (BAND#3) 508 are allocated to radio cells (C#1) 402, (C#2) 404, and (C#3) 406, respectively. The radio frequency bands (BAND#1) 504, (BAND#2) 506, and (BAND#3) 508 span frequency ranges 510, 512, and 514, respectively.

In this case, the radio frequency band (BAND#1) 504 overlaps with the radio frequency band (BAND#2) 506, thus forming an overlap region (OVERLAP#1) 516. The overlap region (OVERLAP#1) 516 is reserved for a simultaneous use in the same transmission direction of the radio cell (C#1) 402 and radio cell (C#2) 404.

In an embodiment, the radio frequency band (BAND#2) 506 overlaps with the radio frequency band (BAND#3) 508, thus forming a second overlap region (OVERLAP#2) 518. The second overlap region (OVERLAP#2) 518 is reserved for a simultaneous use in the same transmission direction of the radio cell (C#2) 404 and radio cell (C#3) 406. The two overlap regions 516 and 518 may be reserved for the simultaneous use in the same transmission direction or they may be reserved for a non-simultaneous use.

The example of FIG. 5 represents a case where each overlap region 516, 518 is associated with two radio frequency bands in maximum. If the radio frequency bands (BAND#1) 504, (BAND#2) 506, and (BAND#3) 508 are allocated in the uplink direction, the base transceiver station 210, 212 providing the cells 402, 404, 406 preferably applies at least two independent antenna elements 222A, 222B, 224A, 224B in reception. In this case, each overlap region 516, 518 may be reserved for the simultaneous use for two mobile stations 210, 212 in maximum operating in the same reuse area 428, each mobile station 210, 212 applying a single transmission antenna to the radio link.

In the case of the example of FIG. 5, the reuse order, i.e. the number of radio frequency bands forming a single overlap region 516, 518, is two. The reuse order indicates the number of radio cells having the same overlap region, i.e. the number of radio links using the same frequencies and applied simultaneously in the same transmission direction. The example of FIG. 5 shows that the overlap region 516, 518 results in increase in the bandwidths 510, 512, 514, and thus provides an improvement in the capacity within the reuse area 428. Furthermore, the maximum capacity in the cell level and link level is increased.

With reference to FIG. 6, radio frequency bands (BAND#1) 604, (BAND#2) 606, and (BAND#3) 608 are allocated to the radio cells (C#1) 402, (C#2) 404, and (C#3) 406, respectively. The radio frequency bands (BAND#1) 604, (BAND#2) 606, and (BAND#3) 608 span the frequency ranges 610, 612, and 614, respectively. In this case, the radio frequency bands (BAND#1) 604, (BAND#2) 606, and (BAND#3) 608 form an overlap region 616, which includes frequency components from all three frequency bands 604, 606, 608. The overlap region 616 is reserved for the simultaneous use in the same transmission direction of the radio cells (C#1) 402, (C#2) 404, and (C#3) 406.

The example of FIG. 6 represents a case where the overlap region 616 is formed by three radio frequency bands. If the radio frequency bands (BAND#1) 604, (BAND#2) 606, and (BAND#3) 608 are allocated in the uplink direction, the base transceiver station 210, 212 providing the cells 402, 404, 406 preferably applies at least three independent antenna elements 222A, 222B in reception. In this case, the overlap region 616 may be reserved for the simultaneous use in maximum of three mobile stations 210, 212 operating in the reuse area 428, each mobile station 210, 212 equipped with a single transmission antenna.

In the example of FIG. 6, the reuse order is three, thus providing an increase in the bandwidths 610, 612, 614 when compared to the bandwidths 510, 512, 514 shown in FIG. 5.

The frequency reuse order may be associated with the number of independent antennas applied in the base transceiver stations 210, 212 and mobile stations 210, 212. Let us denote the frequency reuse order R, the number of receive antennas in a receiver NR, and the number of transmit antennas in a transmitter NT. With the notation adopted, the following equation holds:

$$\frac{{N}_{R}}{{N}_{T}} \geq R . \qquad ( 1 )$$

Equation (1) indicates that the number N_{R} of receive antennas be more than the number of transmit antennas N_{T} in order to enable more than one frequency band 306, 308 to be allocated to a radio cell 214, 216 for a simultaneous use in the same transmission direction.

Equation (1) indicates, for example, that with N_{R}=4 in the base transceiver station 210, 212 and N_{R}=1 in the mobile station 218, 220, four radio cells at maximum may use the same frequencies simultaneously in the same transmission direction. That is, four mobile stations 218, 210, each in a separate cell 214, 216, may transmit to the serving base transceiver station 210, 212 by using the same frequencies simultaneously. If N_{R}=2, the number of radio cells sharing the same frequency region would be two, and the number of mobile stations 218, 210 transmitting at the same frequency would be two.

Equation (1) may be applied to the downlink case. For example, if the number of antennas applied to the transmission in a base transceiver station is two, i.e. N_{T}=1, the minimum number of independent receive antennas in the mobile station is two, i.e. N_{R}=2 in order to allow a frequency reuse order greater than 1. In this case, the frequency reuse order is 2, i.e. R=2, thus allowing an overlap of two frequency bands 306, 308. That is, two base transceiver stations 210, 212 with the same reuse area may transmit simultaneously by using the same frequencies.

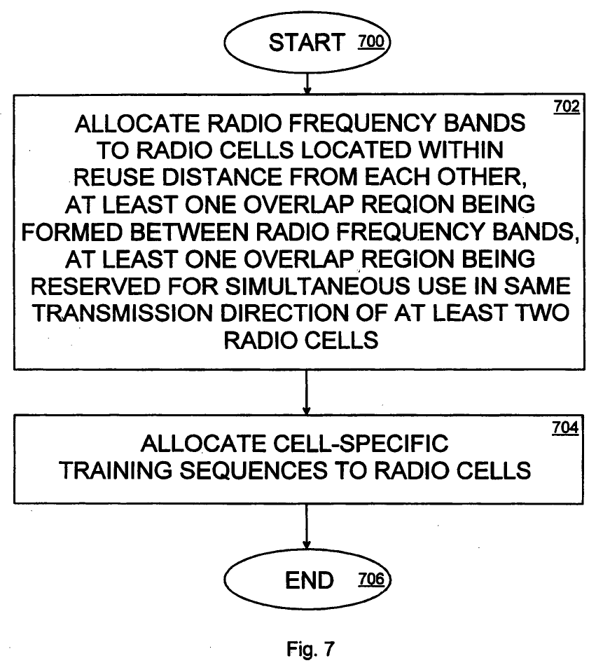

With reference to FIG. 7, a methodology according to embodiments of the invention is described.

In 700, the method starts.

In 702, radio frequency bands 306, 308 are allocated to at least two radio cells 214, 216, the at least two radio cells 214, 216 being located within a reuse distance 238 from each other, at least one overlap region 310 being formed between the radio frequency bands 306, 308, the at least one overlap region 310 being reserved for the simultaneous use in the same transmission direction of the at least two radio cells 214, 216.

In 704, cell-specific training sequences are allocated to the at least two radio cells 214, 216.

In 706, the method ends.

In an embodiment of 702, the radio frequency bands 306, 308 are allocated to at least two adjacent radio cells.

In an embodiment of 702, the radio frequency bands 306, 308 are allocated to the at least two radio cells 214, 216, each radio frequency band 306, 308 including carrier frequencies, the overlap region 310 including at least one carrier frequency shared by the radio frequency bands 306, 308, the at least one carrier frequency being reserved for the simultaneous use in the same transmission direction of the at least two radio cells 214, 216.

In an embodiment of 702, the radio frequency bands 306, 308 are allocated to the at least two radio cells 214, 216, the overlap region 310 being reserved for the simultaneous use in the uplink direction of the at least two radio cells 214, 216.

In an embodiment of 702, the radio frequency bands 306, 308 are allocated to the at least two radio cells 214, 216, the overlap region 310 being reserved for the simultaneous use in the downlink direction of the at least two radio cells 214, 216.

In an aspect, the invention provides a computer program for executing a computer process shown in FIG. 7 and described above.

The computer program may be stored in a data carrier, such as a CD (Compact Disc), a hard drive, a diskette, and a portable memory unit. The computer program may further be transferred with en electric signal in a data network, such as the Internet.

Even though the invention has been described above with reference to an example according to the accompanying drawings, it is clear that the invention is not restricted thereto but it can be modified in several ways within the scope of the appended claims.

1. A method of allocating radio resources in a TDMA cellular telecommunications system, which applies spatial diversity and where radio cells are assigned cell-specific radio frequency bands selected from a plurality of radio frequency bands, the method comprising the step of:
allocating radio frequency bands to at least two radio cells, the at least two radio cells being located within a reuse distance from each other, at least one overlap region being formed between the radio frequency bands, the at least one overlap region being reserved for a simultaneous use in the same transmission direction of the at least two radio cells.

2. The method of claim 1, the method further comprising the step of allocating the radio frequency bands to at least two adjacent radio cells.

3. The method of claim 1, the method further comprising the step of allocating the radio frequency bands to the at least two radio cells, each radio frequency band comprising carrier frequencies, the overlap region comprising at least one carrier frequency shared by the radio frequency bands, and the at least one carrier frequency being reserved for the simultaneous use in the same transmission direction of the at least two radio cells.

4. The method of claim 1, the method further comprising the step of allocating the radio frequency bands to the at least two radio cells, the overlap region being reserved for the simultaneous use in the uplink direction of the at least two radio cells.

5. The method of claim 1, the method further comprising the step of allocating the radio frequency bands to the at least two radio cells, the overlap region being reserved for the simultaneous use in the downlink direction of the at least two radio cells.

6. The method of claim 1, the method further comprising the step of allocating cell-specific training sequences to the at least two radio cells.

7. A system for allocating radio resources in a TDMA cellular telecommunications system, which applies spatial diversity, and where radio cells are assigned cell-specific radio frequency bands selected from a plurality of radio frequency bands, the system comprises:
a frequency allocating network element for allocating radio frequency bands to at least two radio cells located within a reuse distance from each other, at least one overlap region being formed between the radio frequency bands, the at least one overlap region being reserved for a simultaneous use in the same transmission direction of the at least two radio cells.

8. The system of claim 7, wherein the radio cells are adjacent radio cells.

9. The system of claim 7, wherein the frequency allocating network element is configured to allocate the radio frequency bands to the at least two radio cells, each radio frequency band comprising carrier frequencies, the overlap region comprising at least one carrier frequency shared by the radio frequency bands, the at least one carrier frequency being reserved for the simultaneous use in the same transmission direction of the at least two radio cells.

10. The system of claim 7, wherein the transmission direction is the uplink direction.

11. The system of claim 7, wherein the transmission direction is the downlink direction.

12. The system of claim 7 the system further comprising a training sequence allocating network element for allocating cell-specific training sequences to the at least two radio cells.

13. A computer program embodied in a computer readable medium, the computer program executes a computer process for allocating radio resources in a TDMA cellular telecommunications system which applies spatial diversity and where radio cells are assigned cell-specific radio frequency bands selected from a plurality of radio frequency bands, the computer process comprising:
allocating radio frequency bands to at least two radio cells, the at least two radio cells being located within a reuse distance from each other, at least one overlap region being formed between the radio frequency bands, the at least one overlap region being reserved for a simultaneous use in the same transmission direction of the at least two radio cells.

14. A computer program of claim 13, wherein the computer process comprises the step of allocating the radio frequency bands to at least two adjacent radio cells.

15. A computer program of claim 13, wherein the computer process further comprises the step of allocating the radio frequency bands to the at least two radio cells, each radio frequency band including carrier frequencies, the overlap region including at least one carrier frequency common to the radio frequency bands, and the at least one carrier frequency being reserved for the simultaneous use in the same transmission direction of the at least two radio cells.

16. A computer program of claim 13, wherein the computer process comprises the step of allocating the radio frequency bands to the at least two radio cells, the overlap region being reserved for the simultaneous use in the uplink direction of the at least two radio cells.

17. A computer program of claim 13, wherein computer process comprises the step of allocating the radio frequency bands to the at least two radio cells, the overlap region being reserved for the simultaneous use in the downlink direction of the at least two radio cells.

18. A computer program of claim 13, wherein the computer process comprises the step of allocating cell-specific training sequences to the at least two radio cells.

19. An apparatus for allocating radio resources in a TDMA cellular telecommunications system, which applies spatial diversity and where radio cells are assigned cell-specific radio frequency bands selected from a plurality of radio frequency bands, the apparatus comprises:
allocating means for allocating radio frequency bands to at least two radio cells, the at least two radio cells being located within a reuse distance from each other, at least one overlap region being formed between the radio frequency bands, the at least one overlap region being reserved for a simultaneous use in the same transmission direction of the at least two radio cells.
